(19) United States
(12) Patent Application Publication
(10) Pub. No.: US 2007/0269645 A1
(43) Pub. Date: Nov. 22, 2007

(54) Lightweight thermoplastic composite including reinforcing skins

(76) Inventors: Venkat Raghavendran, Forest, VA (US); Thomas Arnold Ebeling, Forest, VA (US)

Correspondence Address: Mark L. Warzel, 10252 Overhill Dr., Santa Ana, CA, 92705, US

(21) Appl. No.: 11/784,515

(22) Filed: Apr. 5, 2007

Related U.S. Application Data
(60) Provisional application No. 60/744,308, filed on Apr. 5, 2006.

(51) Int. Cl. B32B 5/12; D04H 13/00; B32B 27/04; B32B 27/12

(52) U.S. Cl. 428/292.1; 442/394; 428/105; 428/297.4

(57) ABSTRACT

A lightweight fiber reinforced thermoplastic composite having an improved combination of surface roughness, flexural and shear characteristics. The composite generally comprises a fiber reinforced thermoplastic core containing reinforcing fibers bonded together with a first thermoplastic resin in which the core has a first surface and a second surface and at least one first skin applied to the first surface. The first skin comprises a plurality of fibers bonded together with a second thermoplastic resin, with the fibers in each first skin aligned in a unidirectional orientation within the first skin. The composite satisfies at least one of the conditions: an average surface roughness of the outer surface of the first skin is equal to or less than about 4.0 μm/10 mm; the flexural modulus and strength are greater than about 10,000 MPa and greater than about 180 MPa, respectively; and the shear modulus and strength are greater than about 3,000 MPa and greater than about 100 MPa, respectively. In another embodiment, a fiber reinforced thermoplastic composite comprises a fiber reinforced thermoplastic core containing reinforcing fibers bonded together with a first thermoplastic resin, the core having a density of about 0.1 gm/cc to about 2.25 gm/cc and a porosity greater than about 0% by volume. The core has a first surface and a second surface and at least one first skin applied to the first surface, each of the first skins comprising fibers bonded together with a second thermoplastic resin. The first skin comprises a thermoplastic melt impregnated continuous fiber prepreg material, or commingled fiber rovings comprising reinforcing fibers and thermoplastic fibers, with the fibers in the first skin aligned in a unidirectional orientation within the first skin.

### CROSS REFERENCE TO RELATED APPLICATIONS

This application claims the benefit of Provisional Patent Application No. 60/744,308, filed Apr. 5, 2006, which is hereby incorporated by reference in its entirety.

### FIELD OF THE INVENTION

This invention relates generally to lightweight fiber reinforced thermoplastic polymer composites, more particularly to lightweight fiber reinforced thermoplastic polymer composite materials that include outer skins having unidirectional reinforcing fibers, and to certain improvements in the mechanical and surface characteristics of such materials and articles formed therefrom. Although not limited thereto, the invention is useful in the manufacture of automotive, rail, bus, marine, and aerospace articles in which the improved characteristics provide advantages over other materials utilized for such applications.

### BACKGROUND OF THE INVENTION

Driven by a growing demand by industry, governmental regulatory agencies and consumers for durable and inexpensive products that are functionally comparable or superior to metal products, a continuing need exists for improvements in composite articles subjected to difficult service conditions. This is particularly true in the automotive industry where developers and manufacturers of articles for automotive and construction materials applications must meet a number of competing and stringent performance specifications for such articles.

In an effort to address these demands, a number of composite materials have been developed, including glass fiber reinforced thermoplastic composites. Such composites provide a number of advantages, e.g., they can be molded and formed into a variety of suitable products both structural and non-structural, including, among many others, automotive bumpers, interior headliners, and interior and exterior trim parts. Traditional glass fiber composites used in exterior structural applications are generally compression flow molded and are substantially void free in their final part shape. By comparison, low density glass fiber composites used in automotive interior applications are generally semi-structural in nature and are porous and light weight with densities ranging from 0.1 to 1.8 g/cm³ and containing 5% to 95% voids distributed uniformly through the thickness of the finished part. The stringent requirements for certain automotive applications have been difficult to meet, however, for existing glass fiber composite products, particularly where such applications require a desirable combination of properties, such as light weight, good flexural, shear and tensile properties, as well as good surface finish characteristics. As a result, a continuing need exists to provide further improvements in the ability of thermoplastic composite materials to meet such performance and property standards.

### BRIEF DESCRIPTION OF THE INVENTION

Accordingly, in one aspect of the invention, a fiber reinforced composite is provided having an improved combination of surface roughness, flexural and shear characteristics. The composite generally comprises a fiber reinforced thermoplastic core comprising a plurality of reinforcing fibers bonded together with a first thermoplastic resin in which the core has a first surface and a second surface and at least one first skin applied to the first surface. The first skin comprises a plurality of fibers bonded together with a second thermoplastic resin, with a plurality of fibers in each first skin aligned in a substantially unidirectional orientation within the first skin. The composite meets at least one of the following conditions or combinations thereof: an average surface roughness of the outer surface of said first skin is equal to or less than about 4.0 μm/10 mm; the flexural modulus is greater than about 10,000 MPa and the flexural strength is greater than about 180 MPa; and the shear modulus is greater than about 3,000 MPa and the shear strength is greater than about 100 MPa.

In another aspect of the invention, a fiber reinforced composite is provided comprising a fiber reinforced thermoplastic core comprising a plurality of reinforcing fibers bonded together with a first thermoplastic resin, said core having a density of about 0.1 gm/cc to about 2.25 gm/cc and a void content greater than about 0% by volume, and comprising a first surface and a second surface; and at least one first skin applied to said first surface, each said first skin comprising a plurality of fibers bonded together with a second thermoplastic resin, said plurality of fibers in each said first skin aligned in a substantially unidirectional orientation within said first skin, each said first skin comprising a thermoplastic melt impregnated continuous fiber prepreg material, or commingled fiber rovings comprising reinforcing fibers and thermoplastic fibers.

### BRIEF DESCRIPTION OF THE DRAWINGS

FIGS. 1-2 are sectional schematic illustrations of composite thermoplastic sheets in accordance with an embodiment of the present invention.

FIG. 3 is an enlarged schematic illustration of the composite thermoplastic sheet shown in FIG. 1.

FIGS. 4-5 depict Flexural Modulus and Strength properties, respectively, for various impregnation processes as described in the Examples.

FIGS. 6-7 depict Tensile Modulus and Strength properties, respectively, for various impregnation processes as described in the Examples.

FIGS. 8-9 depict Shear Modulus and Strength properties, respectively, for various impregnation processes as described in the Examples.

FIGS. 10-11 depict Average Surface Roughness properties for various impregnation processes as described in the Examples.

### DETAILED DESCRIPTION OF THE INVENTION

As used in the specification and the appended claims, the singular forms “a,” “an,” and “the” include plural referents unless the context clearly dictates otherwise. Thus, for example, reference to “a thermoplastic resin” encompasses a combination or mixture of different resins as well as a single resin, reference to “a skin layer” or “a surface layer” includes a single layer as well as two or more layers that may or may not be the same and may be on one or more sides or surfaces of the composite material, and the like.

As used herein, the term “about” is intended to permit some variation in the precise numerical values or ranges specified. While the amount of the variation may depend on the particular parameter, as used herein, the percentage of the variation is typically no more than 5%, more particularly 3%, and still more particularly 1% of the numerical values or ranges specified.

In this specification and in the claims that follow, reference will be made to a certain terms, which shall be defined to have the following meanings:

The term “basis weight” generally refers to the areal density of a fiber reinforced thermoplastic material, typically expressed in grams per square meter (g/m² or gsm) of the material in sheet form. The term “reduced basis weight” refers to a reduction in the basis weight that may be realized for composites according to the invention relative to a comparative composite not having all of the features of the invention. As used herein, such a “comparative composite material” differs from the inventive material, e.g., in one or more of the characteristics of the fibers, thermoplastic resins, or the characteristics of the layer(s) forming part of the composite.

The term “substantially free” as it is applied to the description of the plurality of fibers in the first skin in which the skin is described as being “substantially free” of fiber cross-over, where an angle that a cross-over fiber makes with the plurality of fibers is equal to or greater than a specified angle, is intended to mean that greater than about 90%, more particularly greater than about 95%, of such fibers are free of fiber cross-over in the skin. This understanding of the meaning of the term “substantially free” is intended to apply to any angular condition for the fiber cross-over.

In general, the composite of the invention includes a thermoplastic core formed from one or more thermoplastic resins and discontinuous fibers dispersed within the thermoplastic resin(s). One or more reinforcing skin layers with unidirectional fibers contained therein may also be included on the surface of the fiber-containing thermoplastic resin. The thermoplastic composite may be formed into various types of articles, e.g. automotive components, such as interior components and exterior body panels, as well as other articles noted herein. Advantageously, the unidirectional fibers provide for lower surface roughness of the composite compared to known composites using reinforcing woven fiber fabrics, while also providing an improved combination of composite flexural, tensile and shear properties compared to other known fiber reinforced thermoplastic composites.

In one aspect of the invention, the composite provides an average surface roughness of the outer surface of the first skin that is equal to or less than about 4.0 μm/10 mm of length, more particularly a surface roughness that is equal to or less than about 3.0 μm/10 mm of length. The mechanical properties of the composite may be similarly improved, as well; e.g., the flexural modulus and strength of the composite may be greater than about 10,000 MPa and greater than about 180 MPa, respectively, the tensile modulus and strength of the composite may be greater than about 10,000 MPa and greater than about 200 MPa, respectively, and the shear modulus and strength of the composite may be greater than about 3,000 MPa and greater than about 100 MPa, respectively. Without limitation, the invention includes composites wherein the mechanical property and surface characteristics of the composite noted herein may be improved individually or in any combination with each other. Such composites include more particular embodiments wherein, e.g., the surface roughness, the flexural properties and the shear properties are each within the limits noted herein, as well as any such other combination.

As described herein, the composite may be non-porous or porous. Advantageously, the thermoplastic core has a porosity greater than about 0% by volume of the thermoplastic core, more particularly between about 0% to about 95% by volume of the thermoplastic core, and still more particularly between about 30% to about 80% by volume of the thermoplastic core. While not required, it is also possible that the composite, which includes the thermoplastic core, is non-porous or has a porosity within the aforementioned ranges; i.e., the porosity of the composite material may generally vary between about 0% and about 95% of the total volume of the composite material.

The thermoplastic resin may generally be any thermoplastic resin having a melt temperature below the resin degradation temperature. Non-limiting examples of such resins include polyolefins, thermoplastic polyolefin blends, polyvinyl polymers, butadiene polymers, acrylic polymers, polyamides, polyesters, polycarbonates, polyestercarbonates, polystyrenes, acrylonitrylstyrene polymers, acrylonitrile-butylacrylate-styrene polymers, polyimides, polyphenylene ether, polyphenylene oxide, polyphenylenesulphide, polyethers, polyetherketones, polyacetals, polyurethanes, polybenzimidazole, and copolymers or mixtures thereof. Other thermoplastic resins can be used that can be sufficiently softened by heat to permit fusing and/or molding without being chemically or thermally decomposed during processing or formation of the composite material. Such other suitable thermoplastic resins will generally be apparent to the skilled artisan.

Fibers suitable for use in the invention include glass fibers, carbon fibers, graphite fibers, synthetic organic fibers, particularly high modulus organic fibers such as para- and meta-aramid fibers, nylon fibers, polyester fibers, or any of the thermoplastic resins mentioned above that are suitable for use as fibers, natural fibers such as hemp, sisal, jute, flax, coir, kenaf and cellulosic fibers, mineral fibers such as basalt, mineral wool (e.g., rock or slag wool), wollastonite, alumina silica, and the like, or mixtures thereof, metal fibers, metalized natural an/or synthetic fibers, ceramic fibers, or mixtures thereof. The fiber content in the thermoplastic core may be from about 15% to about 85%, more particularly from about 45% to about 60%, by weight of the thermoplastic core. Fibers suitable for use herein are further described in the patent literature (as noted herein).

While not limited thereto, the fibers dispersed within the thermoplastic resin, forming the thermoplastic core of the composite, generally have a diameter of from about 5 μm to about 22 μm, and a length of from about 5 mm to about 200 mm; more particularly, the fiber diameter may be from about 10 μm to about 22 μm and the fiber length may be from about 5 mm to about 75 mm.

The composite may generally be prepared in various forms, such as sheets or films, as layered materials on pre-formed substrates, or in other more rigid forms depending on the particular application need. For certain applications, the composite is provided in sheet form and may optionally include one or more additional layers on one or both surfaces of such a sheet. Without limitation, such surface or skin layers may be, e.g., a film, non-woven scrim, a veil, a woven fabric, or a combination thereof. The skin or surface layer may be desirably air permeable and can substantially stretch and spread with the fiber-containing composite sheet during thermoforming and/or molding operations. In addition, such layers may be adhesive, such as a thermoplastic material (e.g., an ethylene acrylic acid copolymer or other such polymers) applied to the surface of the fiber-containing thermoplastic material. Generally, the areal density of the composite material, particularly when in sheet form, varies from about 400 g/m² to about 4000 g/m².

The composite material of the invention may be used to form various intermediate and final form articles, including construction articles or articles for use in automotive applications, including, without limitation, a parcel shelf, package tray, headliner, door module, instrument panel topper, side wall panels such as for recreational vehicles, cargo liners, front and/or rear pillar trim, a sunshade, and the like. Other such articles will be apparent to the skilled artisan. The composite material can be molded into various articles using methods known in the art, for example, pressure forming, thermal forming, thermal stamping, vacuum forming, compression forming, and autoclaving. Such methods are well known and described in the literature, e.g., see U.S. Pat. Nos. 6,923,494 and 5,601,679. Thermoforming methods and tools are also described in detail in DuBois and Pribble's “Plastics Mold Engineering Handbook”, Fifth Edition, 1995, pages 468 to 498.

It should be noted that while the inventive composite provides an improved combination of flexural, tensile, shear and surface roughness characteristics, it is not necessary that all of these characteristics be individually improved. While improvement in each of these characteristics is certainly desirable, for the purposes described herein, an improved combination results if one, more than one, or all of these characteristics is or are improved relative to non-inventive or known composites.

As the thermoplastic resin containing fibers, the composite material of the invention may, according to one embodiment, include a low density glass mat thermoplastic composite (GMT). One such mat is prepared by AZDEL, Inc. and sold under the trademark SUPERLITE® mat. Preferably, the areal density of the such a GMT is from about 400 grams per square meter of the GMT (g/m²) to about 4000 g/m², although the areal density may be less than 400 g/m² or greater than 4000 g/m² depending on the specific application needs. Preferably, the upper density should be less than about 4000 g/m².

The SUPERLITE® mat is generally prepared using chopped glass fibers, a thermoplastic resin and a thermoplastic polymer film or films and or woven or non-woven fabrics made with glass fibers or thermoplastic resin fibers such as polypropylene (PP), polybutylene terephthalate (PBT), polyethylene terephthalate (PET), polycarbonate (PC), a blend of PC/PBT, or a blend of PC/PET. Generally, PP, PBT, PET, and PC/PET and PC/PBT blends are the preferred thermoplastic resins. To produce the low density GMT, the materials and other additives are metered into a dispersing foam contained in an open top mixing tank fitted with an impeller. The foam aides in dispersing the glass fibers and thermoplastic resin binder. The dispersed mixture of glass and thermoplastic resin is pumped to a head-box located above a wire section of a paper machine via a distribution manifold. The foam, not the glass fiber or thermoplastic resin, is then removed as the dispersed mixture passes through a moving wire screen using a vacuum, continuously producing a uniform, fibrous wet web. The wet web is passed through a dryer to reduce moisture content and to melt the thermoplastic resin. When the hot web comes out of the dryer, a thermoplastic film may be laminated into the web by passing the web of glass fiber, thermoplastic resin and thermoplastic polymer film or films through the nip of a set of heated rollers. A non-woven and/or woven fabric layer may also be attached along with or in place thermoplastic film to one side or to both sides of the web to facilitate ease of handling the glass fiber-reinforced mat. The SUPERLITE® composite is then passed through tension rolls and continuously cut (guillotined) into the desired size for later forming into an end product article. Further information concerning the preparation of such GMT composites, including suitable materials used in forming such composites that may also be utilized in the present invention, may be found in a number of U.S. patents, e.g., U.S. Pat. Nos. 6,923,494, 4,978,489, 4,944,843, 4,964,935, 4,734,321, 5,053,449, 4,925,615, 5,609,966 and U.S. Patent Application Publication Nos. US 2005/0082881, US 2005/0228108, US 2005/0217932, US 2005/0215698, US 2005/0164023, and US 2005/0161865.

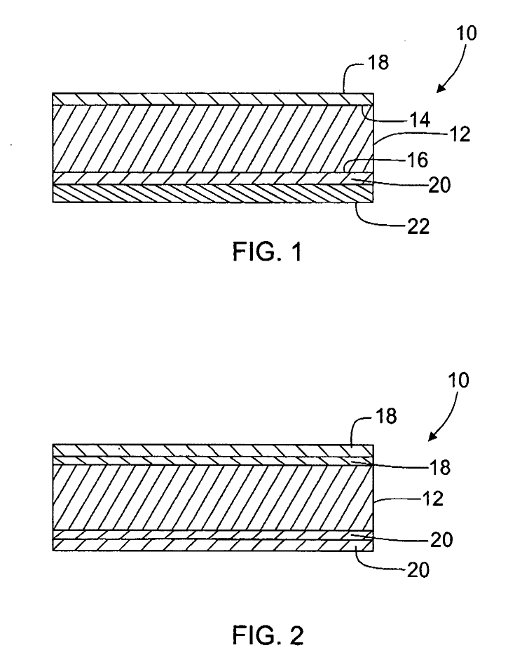

The present invention may be further understood in terms of non-limiting illustrative figures. FIGS. 1 and 2, for example, are sectional schematic illustrations of a lightweight thermoplastic composite 10. In an exemplary embodiment, lightweight composite thermoplastic composite 10 includes a lightweight porous core 12 having a first surface 14 and a second surface 16. A first reinforcing skin 18 is attached to first surface 14 of core 12. A second reinforcing skin 20 may be attached to second surface 16 of core 12. A decorative skin 22 may be bonded to second reinforcing skin 20. The thermoplastic composite 10 may include decorative skins 22 bonded to first and second reinforcing skins 18 and 20, or no decorative skins.

Core 12 is formed from a web made up of open cell structures formed by random crossing over of reinforcing fibers held together, at least in part, by one or more thermoplastic resins, where the void content of the core 12 ranges in general between about 0% and about 95% and in particular between about 30% and about 80% of the total volume of core 12. In another embodiment, porous core 12 is made up of open cell structures formed by random crossing over of reinforcing fibers held together, at least in part, by one or more thermoplastic resins, where about 40% to about 100% of the cell structure are open and allow the flow of air and gases through. Core 12 has a density in one embodiment of about 0.1 gm/cc to about 2.25 gm/cc, in another embodiment about 0.1 gm/cc to about 1.8 gm/cc, and in another embodiment about 0.3 gm/cc to about 1.0 gm/cc. Core 12 may be formed using known manufacturing process, for example, a wet laid process, an air laid process, a dry blend process, a carding and needle process, and other processes that are employed for making non-woven products. Combinations of such manufacturing processes may also be used.

Core 12 may include about 15% to about 85% by weight of reinforcing fibers having an average length of between about 5 mm and about 200 mm, and about 15% to about 80% by weight of a wholly or substantially unconsolidated fibrous or particulate thermoplastic materials, where the weight percentages are based on the total weight of core 12. In another embodiment, core 12 includes about 30% to about 55% by weight of reinforcing fibers. In another embodiment, core 12 includes reinforcing fibers having an average length of between about 5 mm and about 25 mm. As noted herein, suitable fibers include, but are not limited to metal fibers, metalized inorganic fibers, metalized synthetic fibers, glass fibers, graphite fibers, carbon fibers, ceramic fibers, mineral fibers, basalt fibers, inorganic fibers, aramid fibers, kenaf fibers, jute fibers, flax fibers, hemp fibers, cellulosic fibers, sisal fibers, coir fibers, and mixtures thereof.

In one exemplary embodiment, reinforcing fibers having an average length of about 5 mm to about 200 mm are added with thermoplastic powder particles such as polypropylene powder, to an agitated aqueous foam. In another embodiment, reinforcing fibers having an average length of about 5 mm to about 75 mm, or more particularly, about 5 mm to about 50 mm may be used. The components are agitated for a sufficient time to form a dispersed mixture of the reinforcing fibers and thermoplastic powder in the aqueous foam. The dispersed mixture is then laid down on any suitable support structure, for example, a wire mesh, and then the water is evacuated through the support structure forming a web. The web is dried and heated above the softening temperature of the thermoplastic powder. The web is then cooled and pressed to a predetermined thickness to produce core 12 having a porosity of greater than about 0%, more particularly between about 5% to about 95% by volume.

The web is heated above the softening temperature of the thermoplastic resins in core 12 to substantially soften the plastic materials and is passed through one or more consolidation devices, for example calendaring rolls, double belt laminators, indexing presses, multiple daylight presses, autoclaves, and other such devices used for lamination and consolidation of sheets and fabrics so that the plastic material can flow and wet out the fibers. The gap between the consolidating elements in the consolidation devices are set to a dimension less than that of the unconsolidated web and greater than that of the web if it were to be fully consolidated, thus allowing the web to expand and remain substantially permeable after passing through the rollers. In one embodiment, the gap is set to a dimension about 5% to about 10% greater than that of the web if it were to be fully consolidated. A fully consolidated web means a web that is fully compressed and substantially void free. A fully consolidated web would have less than about 5% void content and have negligible open cell structure.

Particulate plastic materials may include short plastics fibers that can be included to enhance the cohesion of the web structure during manufacture. Bonding is affected by utilizing the thermal characteristics of the plastic materials within the web structure. The web structure is heated sufficiently to cause the thermoplastic component to fuse at its surfaces to adjacent particles and fibers.

In one embodiment, the thermoplastic resin used to form core 12 is, at least in part, in a particulate form. Suitable thermoplastics include all of the resins noted hereinabove, without limitation.

Generally, thermoplastic resins in particulate form need not be excessively fine, although particles coarser than about 1.5 millimeters tend not flow sufficiently during the molding process to produce a homogenous structure. The use of larger particles can also result in a reduction in the flexural modulus of the material when consolidated.

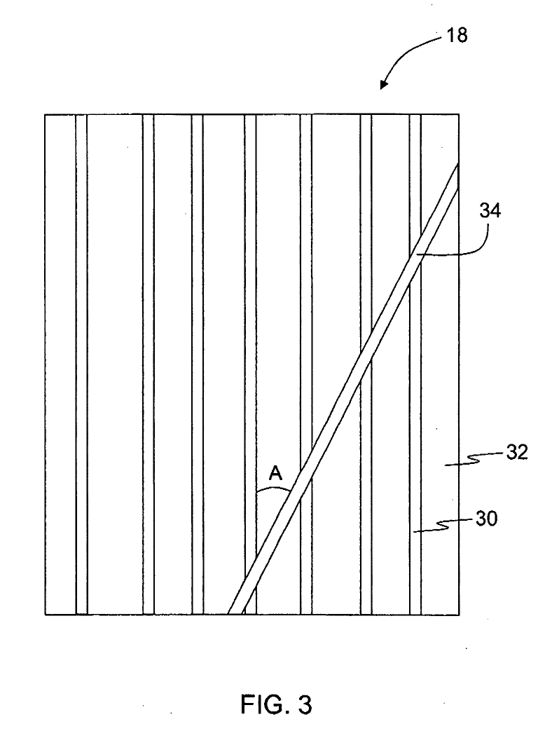

Referring to FIG. 3, first reinforcing skin 18 includes a plurality of unidirectional reinforcing fibers 30 bonded together by a thermoplastic resin 32. By “unidirectional” it is meant that fibers are aligned substantially parallel to each other so that the longitudinal axis of fibers 30 are substantially parallel. Further, skin 18 is substantially free of fiber cross-over where an angle A that a cross-over fiber 34 makes with the longitudinal axis of the aligned fibers 30 is equal to or greater than 30 degrees. In an embodiment that includes multiple first reinforcing skins 18, adjacent first reinforcing skins 18 include reinforcing fibers that are unidirectional in each skin 18 but the aligned fibers 30 in one skin 18 may be arranged at an angle to the aligned fibers 30 in the adjacent skin 18. This angle ranges from 0 degrees to about 90 degrees. Second reinforcing skin 20 (as shown in FIGS. 1 and 2), similar to first reinforcing skin 18, includes a plurality of unidirectional reinforcing fibers 30 bonded together by a thermoplastic resin 32. Also, in an embodiment that includes multiple second reinforcing skins 20, adjacent second reinforcing skins 20 include reinforcing fibers that are unidirectional in each skin 20 but the aligned fibers 30 in one skin 20 may be arranged at an angle to the aligned fibers 30 in the adjacent skin 20.

Reinforcing skins 18 and 20 are prepreg structures formed by impregnating a resin on and around aligned fibers 30. Various methods of forming the prepreg structure may be utilized, including without limitation, solution processing, slurry processing, direct impregnation of a fiber tow with molten polymer, fiber co-mingling, sintering of thermoplastic powder into a fiber tow, and the like. Such techniques are generally known in the art and will only be briefly described herein.

More particularly, solution processing involves dissolution of the resin polymer in a solvent and impregnation of a fiber tow with the resulting low viscosity solution. Suitable solvents used include, but are not limited to, methylene chloride, acetone and N-methyl pyrrolidone. Suitable resins used include, but are not limited to, epoxies, polyimides, polysulfone, polyphenyl sulfone and polyether sulfone. Complete removal of solvent after impregnation is usually needed, and is often a difficult step.

Slurry processing provides another method of forming the prepreg structure, wherein resin polymer particles are suspended in a liquid carrier forming a slurry with the fiber tow passed through the slurry to thereby trap the particles within the fiber tow.

The prepreg structure can also be formed by direct impregnation of the fiber tow with molten polymer. For thermoset resins like epoxy, temperature and reaction kinetics allow for a continuous melt impregnation before reaction. For thermoplastics, two approaches can generally be used. One approach is to use a cross head extruder that feeds molten polymer into a die through which the rovings pass to impregnate the fiber tow. Another approach is to pass the fibers through a molten resin bath fitted with impregnation pins to increase the permeability of the polymer into the tow. The impregnation pins can be heated to decrease viscosity locally to further improve the impregnation process. In either case, the force exerted on the fibers, for example, die pressure for the crosshead extruder, can sometimes be high which can cause fiber damage.

Fiber co-mingling can also be used to form the prepreg structure. in which a thermoplastic resin is spun into a fine yarn and co-mingled with the reinforcing fiber tow to produce a co-mingled hybrid yarn. These hybrid yarns may then be consolidated to form composite films.

The prepreg structure may also be formed by introducing dry thermoplastic powder into a fiber tow that is then processed by heating to sinter the powder particles onto the fibers. This technique includes passing the fiber tow through a bed (either fluidized or loosely packed) of thermoplastic powder, for example, polypropylene particles with an average diameter of about 250 microns. The particles stick to the fibers due to electrostatic attraction. The tow is then heated and passed through a die to produce an impregnated tow. The impregnation is macroscopic, i.e. the particles coat clusters of fibers rather than individual fibers leaving unwetted areas and voids. The process is targeted mainly at producing short fiber reinforced thermoplastics.

The reinforcing fibers described above as suitable for use in making core 12 are also suitable in reinforcing skins 18 and 20. The reinforcing fibers in core 12 may be the same as or different from the reinforcing fibers in skins 18 and 20. The reinforcing fibers in skins 18 may also be the same as or different from the reinforcing fibers in skin 20.

Similarly, the thermoplastic resins described above as suitable for use in core layer 12 may also be used in reinforcing skins 18 and 20. The thermoplastic resin in core 12 may be the same as or different from the thermoplastic resin in skins 18 and 20. The thermoplastic resin in skins 18 may also be the same as or different from the thermoplastic resin in skins 20.

Reinforcing skins 18 and 20 may be attached to core 12 during the manufacturing process of core 12 or reinforcing skins 18 and 20 can be attached prior to forming an article, for example, an automotive interior component or an automobile exterior panel. Without limitation, reinforcing skins 18 and 20 can be attached to core 12 by laminating the skin(s) to core 12, sonic welding of the skin(s) to core 12, or simply laid across core 12 before the article forming process. Other suitable techniques known in the art may be used, provided the advantages of the invention are achieved.

In one exemplary embodiment, an article is formed from thermoplastic composite 10 by heating the composite to a temperature sufficient to melt the thermoplastic resin. The heated thermoplastic composite 10 is then positioned in a mold, such as a matched aluminum mold, heated to about 160° F. and stamped into the desired shape using a low pressure press. Thermoplastic composite 10 can be molded into various articles using any method known in the art including, e.g., thermal forming, thermal stamping, vacuum forming, compression forming, and autoclaving.

In another embodiment, decorative layer 22 is applied to second reinforcing skin 20 by any known technique, for example, lamination, adhesive bonding, and the like. Decorative layer 22 may be formed, e.g., from a thermoplastic film of polyvinyl chloride, polyolefins, thermoplastic polyesters, thermoplastic elastomers, or the like. Decorative layer 22 may also be a multi-layered structure that includes a foam core formed from, e.g., polypropylene, polyethylene, polyvinyl chloride, polyurethane, and the like. A fabric may be bonded to the foam core, such as woven fabrics made from natural and synthetic fibers, organic fiber non-woven fabric after needle punching or the like, raised fabric, knitted goods, flocked fabric, or other such materials. The fabric may also be bonded to the foam core with a thermoplastic adhesive, including pressure sensitive adhesives and hot melt adhesives, such as polyamides, modified polyolefins, urethanes and polyolefins. Decorative layer 22 may also be made using spunbond, thermal bonded, spunlace, melt-blown, wet-laid, and/or dry-laid processes.

While the invention has been described in terms of various specific embodiments, those skilled in the art will recognize that the invention can be practiced with modification within the spirit and scope of the claims.

All patents, patent applications, and publications mentioned herein are hereby incorporated by reference in their entireties.

### Experimental

Samples for the tests were prepared with SuperLite® core sheets (Azdel, Inc., Lynchburg, Va.) which are glass filled polypropylene resin based sheet materials weighing nominally 1600 g/m² and having nominally ½ inch long glass fibers and a glass fiber content of 55% by weight.

Continuous unidirectional glass fiber reinforced polypropylene tapes were manufactured using melt impregnation, aqueous slurry, commingled fibers processes and were sourced from different vendors. The Plytron melt impregnated tapes were sourced from Gurit Composite Technologies, Flurlingen, Switzerland, Preglon melt impregnated tapes were sourced from Mitsui Chemicals Co., Japan as 0/90 cross ply bidirectional tapes. The aqueous slurry based tapes were sourced from Phoenixx TPC of Taunton, Mass. The Commingled fiber tapes were sourced from Baycomp division of the Performance Materials, Inc. Canada. The Twintex bulk weave fabrics made with commingled fibers were sourced from Vetrotex Certainteed, the towpreg weave product made using dry powder impregnated tapes was sourced from Hexcel Composites, Salt Lake City Utah.

Film stacking was carried out using the style7628 plain weave glass fiber based fabric from BGF Industries, Greensboro, N.C. and Polypropylene. film from American Profol Inc. Cedar Rapids, Iowa.

All the unidirectional fiber reinforced multilayer composite panels were prepared using the above mentioned unidirectional tapes pre-laminated as 0/90 cross ply skins and applying them on both top and bottom surfaces of the porous core material (SuperLite®) and vacuum laminating them at 200° C. for 45 minutes to produce the multi-layer composite.

The woven fiber reinforced multilayer composite panels were prepared using the above mentioned bulk weave fabric or the towpreg weave or the film stacked plain weave fabric and applying them on both top and bottom surfaces of the porous core material and vacuum laminating the assembly at 200° C. for 45 minutes to produce the multilayer composite.

### Flexural Property Measurements

The flexural were conducted on the multilayer composites mentioned above according to the ISO 14125 test method. The samples for the flexural tests were nominally 25 mm wide and had a support span of 64 mm.

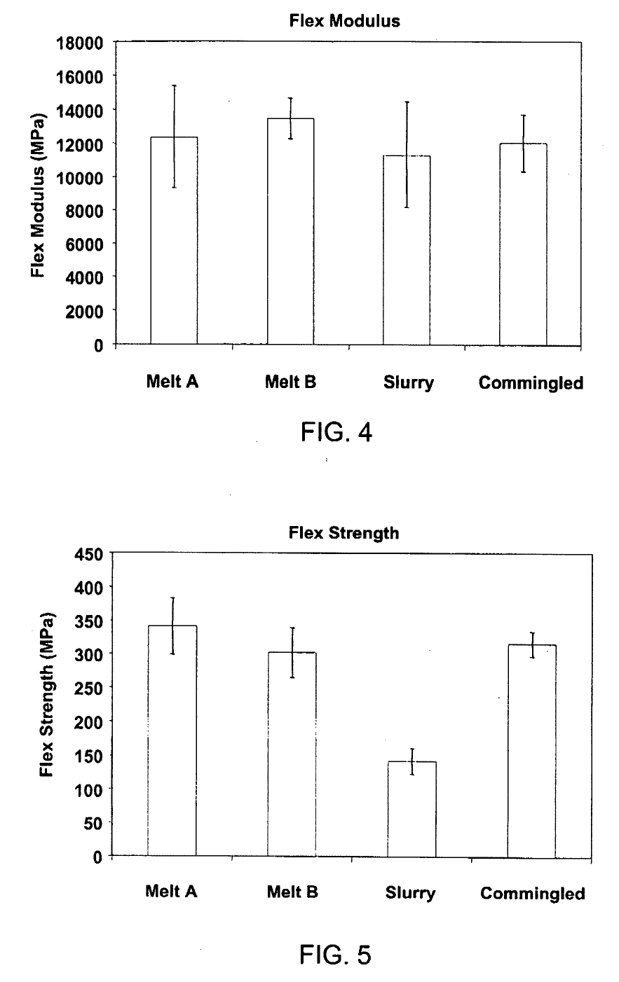

Results for the flexural measurements are shown in FIGS. 4-5.

### Tensile Property Measurements

The tensile tests were conducted on the bidirectional 0/90 cross-ply laminates made with the unidirectional tapes or the woven products mentioned above. All the tensile tests were conducted according to ISO 527 test method. The dogbone shaped samples for the test were produced using a die cut punch method. The gage length of the test specimen was 50 mm.

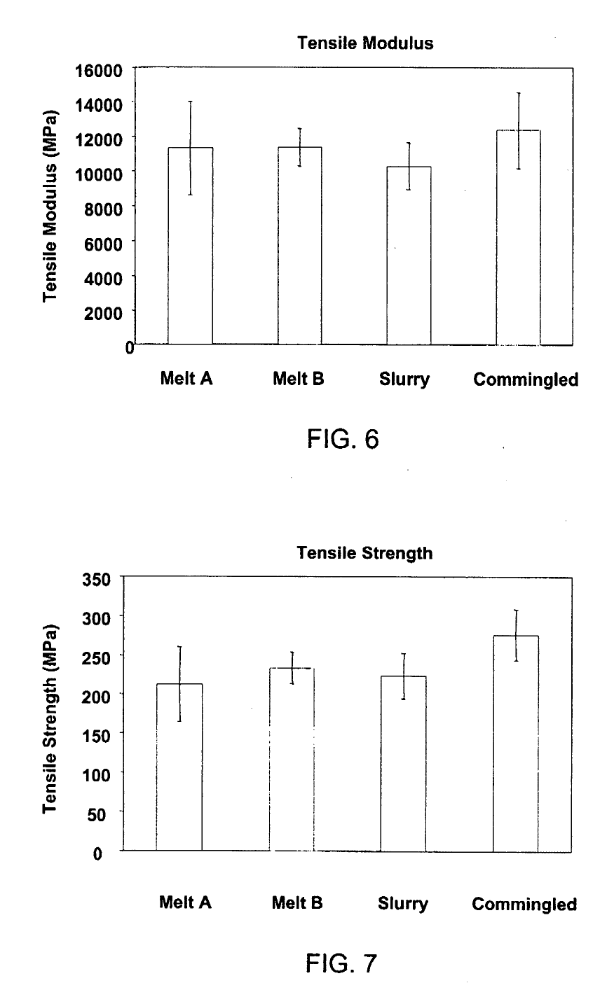

Results for the tensile measurements are shown in FIGS. 6-7.

### Shear Property Measurements

The shear tests were conducted on the multilayer composites mentioned above according to the ISO 14130 test method. The short beam shear test samples were nominally 10 mm wide and had a span between the supports of 12.5 mm.

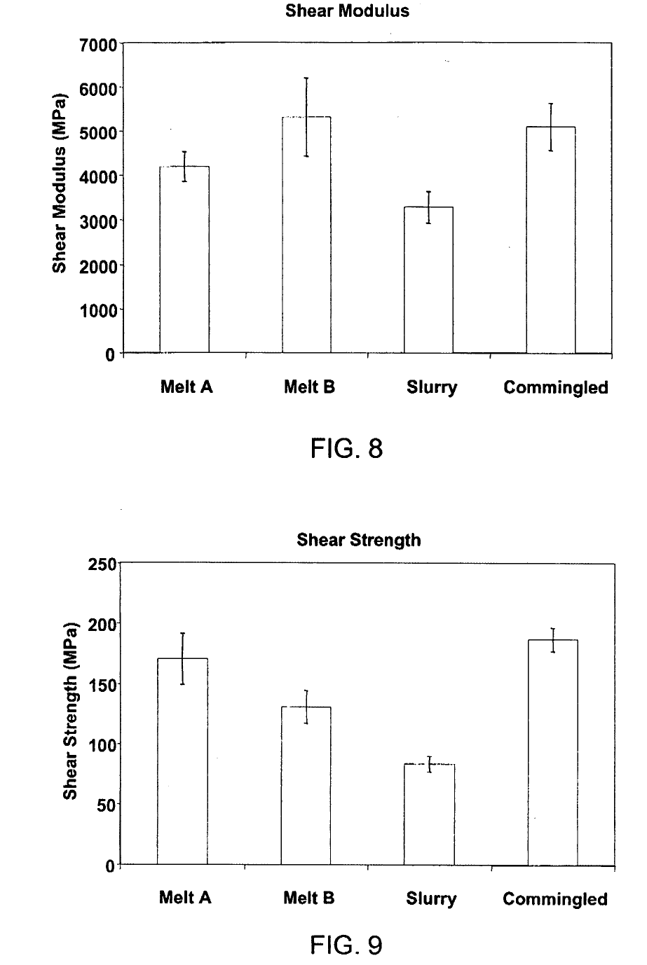

Results for the shear measurements are shown in FIGS. 8-9.

### Surface Roughness Measurements

The samples for the surface roughness measurements were prepared using vacuum lamination with a polished steel plate placed next to surface being measured. The surface roughness measurements were carried out using a Mahr Perthometer according to the DIN 4768/ISO 4278-1 test method and average surface roughness information was reported as average magnitude of roughness in prn for 10 mm length of surface traversal by the probe.

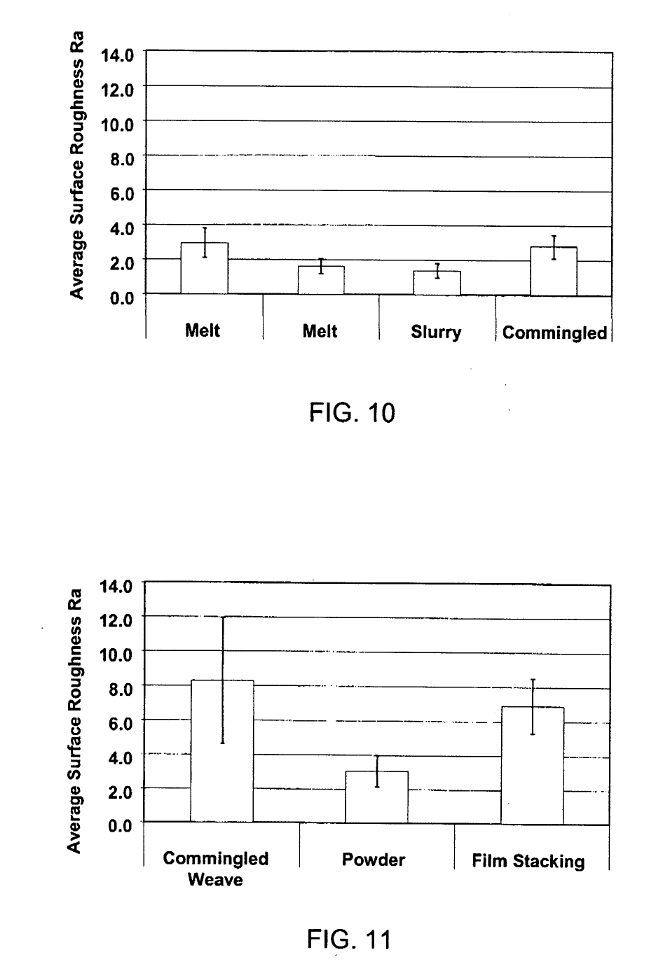

Results for the surface roughness measurements are shown in FIGS. 10-11.

What is claimed is:

1. A fiber reinforced composite having an improved combination of surface roughness, flexural and shear characteristics, comprising:
a fiber reinforced thermoplastic core comprising a plurality of reinforcing fibers bonded together with a first thermoplastic resin, said core comprising a first surface and a second surface; and
at least one first skin applied to said first surface,
each said first skin comprising a plurality of fibers bonded together with a second thermoplastic resin, said plurality of fibers in each said first skin aligned in a unidirectional orientation within said first skin,
wherein, the composite meets at least one of the following conditions or combinations thereof:
an average surface roughness of the outer surface of said first skin is equal to or less than about 4.0 μm/10 mm;
the flexural modulus is greater than about 10,000 MPa and the flexural strength is greater than about 180 MPa; and
the shear modulus is greater than about 3,000 MPa and the shear strength is greater than about 100 MPa.

2. The fiber reinforced composite of claim 1, wherein the average surface roughness of the outer surface of said first skin is equal to or less than about 4.0 μm/10 mm

3. The fiber reinforced composite of claim 1, wherein the flexural modulus is greater than about 10,000 MPa and the flexural strength is greater than about 180 MPa.

4. The fiber reinforced composite of claim 1, wherein the shear modulus is greater than about 3,000 MPa and the shear strength is greater than about 100 MPa.

5. The fiber reinforced composite of claim 1, further comprising:
at least one second skin applied to said second surface,
each said second skin comprising a plurality of fibers bonded together with a third thermoplastic resin.

6. The fiber reinforced composite of claim 1, wherein said plurality of fibers in the first skin are substantially free of fiber cross-over where an angle that a cross-over fiber makes with said plurality of fibers is equal to or greater than about 30 degrees.

7. The fiber reinforced composite of claim 4, wherein an angle defined by a longitudinal axis of said plurality of fibers in one first skin and a longitudinal axis of said plurality of fibers in an adjacent first skin ranges between 0 degrees to about 90 degrees; and
an angle defined by a longitudinal axis of said plurality of fibers in one second skin and a longitudinal axis of said plurality of fibers in an adjacent second skin ranges between 0 degrees to about 90 degrees.

8. An article formed from the fiber reinforced composite of claim 1.

9. A fiber reinforced composite comprising:
a fiber reinforced thermoplastic core comprising a plurality of reinforcing fibers bonded together with a first thermoplastic resin, said core having a density of about 0.1 gm/cc to about 2.25 gm/cc and a porosity greater than about 0% by volume, and comprising a first surface and a second surface; and
at least one first skin applied to said first surface,
each said first skin comprising a plurality of fibers bonded together with a second thermoplastic resin, said plurality of fibers in each said first skin aligned in a unidirectional orientation within said first skin, each said first skin comprising a thermoplastic melt impregnated continuous fiber prepreg material, or commingled fiber rovings comprising reinforcing fibers and thermoplastic fibers.

10. The fiber reinforced composite of claim 9, further comprising:
at least one second skin applied to said second surface,
each said second skin comprising a plurality of fibers bonded together with a third thermoplastic resin.

11. The fiber reinforced composite of claim 9, wherein said plurality of fibers in the first skin are substantially free of fiber cross-over where an angle that a cross-over fiber makes with said plurality of fibers is equal to or greater than about 30 degrees.

12. The fiber reinforced composite of claim 9, wherein said plurality of fibers in the first skin are substantially free of fiber cross-over where an angle that a cross-over fiber makes with said plurality of fibers is equal to or greater than about 20 degrees.

13. The fiber reinforced composite of claim 9, wherein an angle defined by a longitudinal axis of said plurality of fibers in one first skin and a longitudinal axis of said plurality of fibers in an adjacent first skin ranges between 0 degrees to about 90 degrees; and
an angle defined by a longitudinal axis of said plurality of fibers in one second skin and a longitudinal axis of said plurality of fibers in an adjacent second skin ranges between 0 degrees to about 90 degrees.

14. The fiber reinforced composite of claim 9, wherein the fiber content is between about 40 wt. % and about 80 wt. % of the composite.

15. The fiber reinforced composite of claim 9, wherein the core comprises about 20 wt. % to about 80 wt. % reinforcing fibers.

16. The fiber reinforced composite of claim 9, wherein at least one of said reinforcing fibers in said core, said fibers in each said first skin, and said fibers in each said second skin are independently selected from metal fibers, metalized inorganic fibers, metalized synthetic fibers, glass fibers, polyester fibers, polyamide fibers, graphite fibers, carbon fibers, ceramic fibers, mineral fibers, basalt fibers, inorganic fibers, aramid fibers, kenaf fibers, jute fibers, flax fibers, hemp fibers, cellulosic fibers, sisal fibers, coir fibers, or combinations thereof.

17. The fiber reinforced composite of claim 9, wherein at least one of said first thermoplastic resin, said second thermoplastic resin, and said third thermoplastic resin is independently selected from polyolefins, thermoplastic polyolefin blends, polyvinyl polymers, butadiene polymers, acrylic polymers, polyamides, polyesters, polycarbonates, polyestercarbonates, polystyrenes, acrylonitrylstyrene polymers, acrylonitrile-butylacrylate-styrene polymers, polyimides, polyphenylene ether, polyphenylene oxide, polyphenylenesulphide, polyethers, polyetherketones, polyacetals, polyurethanes, polybenzimidazole, and copolymers or mixtures thereof.

18. The fiber reinforced composite of claim 9, comprising two to six first skins and two to six second skins.

19. The fiber reinforced composite of claim 9, wherein an average surface roughness of the outer surface of said first skin is equal to or less than about 4.0 μm/10 mm.

20. An article formed from the fiber reinforced composite of claim 9.
